(19) United States
(12) Patent Application Publication
(10) Pub. No.: US 2025/0193855 A1
(43) Pub. Date: Jun. 12, 2025

(54) SLOT FORMAT WITH LOW POWER SIGNALS

(71) Applicant: Samsung Electronics Co., Ltd., Suwon-si (KR)

(72) Inventor: Hongbo Si, Allen, TX (US)

(21) Appl. No.: 18/961,165

(22) Filed: Nov. 26, 2024

Related U.S. Application Data
(60) Provisional application No. 63/606,916, filed on Dec. 6, 2023.
(60) Provisional application No. 63/621,930, filed on Jan. 17, 2024.

(51) Int. Cl. H04W 72/0446; H04W 52/02; H04W 72/231; H04W 76/28

(52) U.S. Cl. CPC H04W 72/0446; H04W 52/0235; H04W 72/231; H04W 76/28

(57) ABSTRACT

Apparatuses and methods for slot formats with low power signals. A method of a user equipment (UE) in a wireless communication system includes receiving a set of higher layer parameters and determining whether a first slot format is included in the set of higher layer parameters. The method further includes determining, based on the set of higher layer parameters, a set of slots for receiving a low power signal by a low-power receiver (LR) of the UE. When the first slot format is included in the set of higher layer parameters, the method further includes determining, based on the first slot format, whether a slot in the set of slots is an uplink slot, a flexible slot, or a downlink slot and receiving the low power signal based on a determination that the slot in the set of slots is not an uplink slot.

### CROSS-REFERENCE TO RELATED AND CLAIM OF PRIORITY

The present application claims priority under 35 U.S.C. § 119 (e) to U.S. Provisional Patent Application No. 63/606,916 filed on Dec. 6, 2023, and U.S. Provisional Patent Application No. 63/621,930 filed on Jan. 17, 2024, which are hereby incorporated by reference in their entirety.

### TECHNICAL FIELD

The present disclosure relates generally to wireless communication systems and, more specifically, the present disclosure is related to apparatuses and methods for slot format(s) with low power signals.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to slot format(s) with low power signals.

In one embodiment, a user equipment (UE) in a wireless communication system is provided. The UE includes a transceiver configured to receive a set of higher layer parameters, a low-power receiver (LR), and a processor operably coupled to the transceiver and the LR. The processor is configured to determine whether a first slot format is included in the set of higher layer parameters, determine, based on the set of higher layer parameters, a set of slots for receiving a low power signal by the LR, and when the first slot format is included in the set of higher layer parameters, determine, based on the first slot format, whether a slot in the set of slots is an uplink slot, a flexible slot, or a downlink slot. The LR is further configured to receive the low power signal based on a determination that slot in the set of slots is not an uplink slot.

In another embodiment, a method of a UE in a wireless communication system is provided. The method includes receiving a set of higher layer parameters; determining whether a first slot format is included in the set of higher layer parameters; and determining, based on the set of higher layer parameters, a set of slots for receiving a low power signal by a LR of the UE. The method further includes when the first slot format is included in the set of higher layer parameters, determining, based on the first slot format, whether a slot in the set of slots is an uplink slot, a flexible slot, or a downlink slot and receiving the low power signal based on a determination that the slot in the set of slots is not an uplink slot.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates a flowchart of an example UE procedure for determining a slot format according to embodiments of the present disclosure;

FIG. 6 illustrates a flowchart of an example UE procedure for determining whether to receive a low power signal according to embodiments of the present disclosure;

FIG. 7 illustrates a diagram of an example low power wake up signal (LP-WUS) reception/monitoring occasion(s) according to embodiments of the present disclosure;

FIG. 8 illustrates a diagram of an example LP-WUS reception/monitoring occasion(s) according to embodiments of the present disclosure;

FIG. 9 illustrates a flowchart of an example UE procedure for activation/deactivation of cell discontinuous transmission (DTX)/discontinuous reception (DRX) operations according to embodiments of the present disclosure; and

FIG. 10 illustrates a flowchart of an example UE procedure for monitoring physical downlink control channel (PDCCH) according to embodiments of the present disclosure.

### DETAILED DESCRIPTION

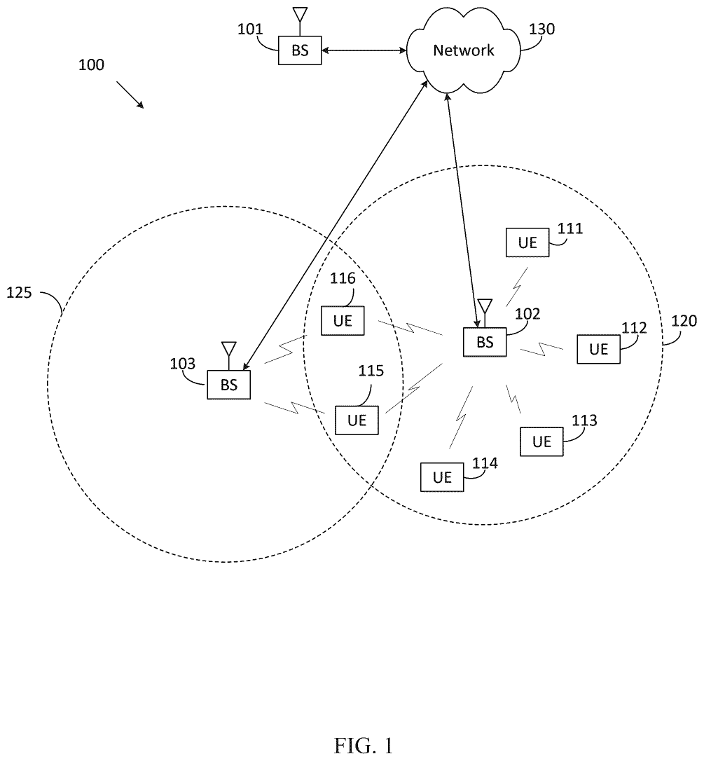

FIGS. 1-10, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v17.1.0, “NR; Physical channels and modulation;” [2] 3GPP TS 38.212 v17.1.0, “NR; Multiplexing and channel coding;” [3] 3GPP TS 38.213 v17.1.0, “NR; Physical layer procedures for control;” [4] 3GPP TS 38.214 v17.1.0, “NR; Physical layer procedures for data;” and [5] 3GPP TS 38.331 v17.1.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for utilizing slot format(s) with low power signals. In certain embodiments, one or more of the BSs 101-103 include circuitry, programing, or a combination thereof to support slot format(s) with low power signals.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

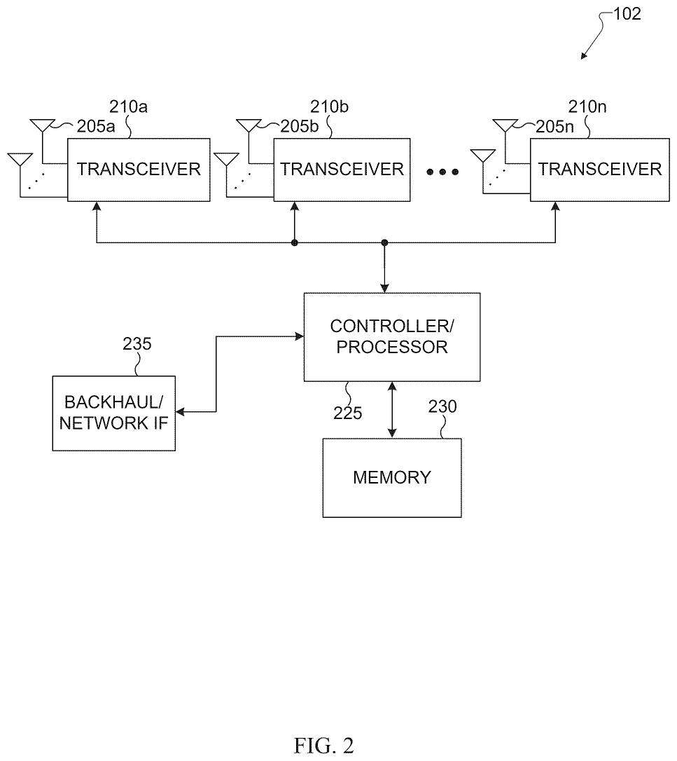

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for slot format(s) with low power signals. Any of a wide variety of other functions could be supported in the gNB 102 by the controller/processor 225.

The controller/processor 225 is also capable of executing programs and other processes resident in the memory 230, such as processes related to supporting slot format(s) with low power signals. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

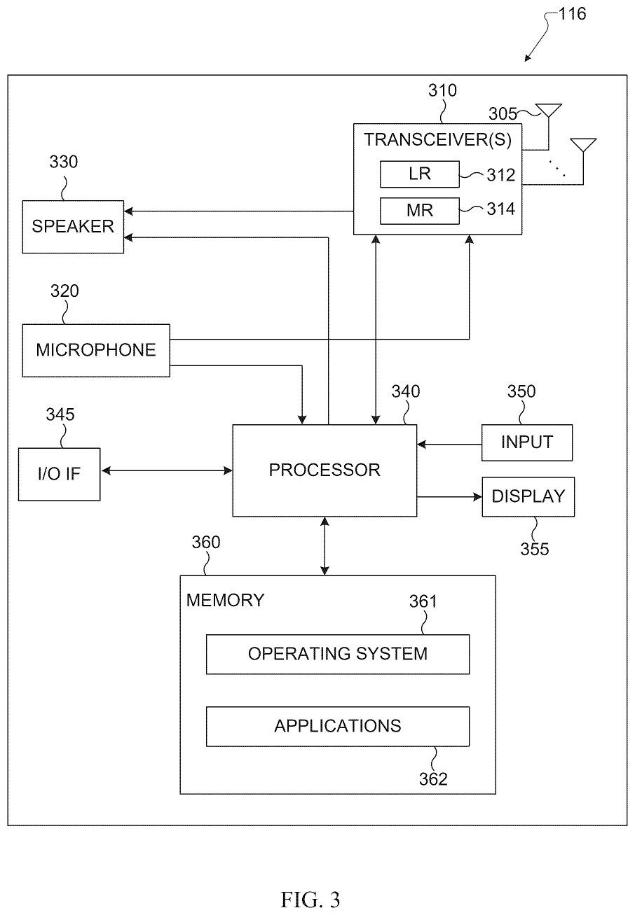

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for utilizing slot format(s) with low power signals as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

In various embodiments, the transceiver(s) 310 include or are at least one LR 312 and at least one MR 314. For example, as discussed in greater detail below, the LR 312 may be configured or utilized to receive low power signals (e.g., a LP-WUS), for example, when the UE 116 is in a sleep state (e.g., such as an ultra-deep sleep state as discussed in greater detail below), while the MR 314 is powered off or in a low power state. For example, in some embodiments, the LR 312 may be a component of the transceiver(s) 310 used or powered on when the UE 116 is in the sleep state while the MR 314 is the transceiver(s) 310 and used when the UE 116 is not in the sleep state. In another example, in other embodiments, the LR 312 may be receiver that is separate or discrete from the transceivers(s) 310 which is the MR 314 used for ordinary reception operations when the UE 116 is not in the sleep state.

Analogously, in such embodiments, the processor 340 includes or is at least one of the low-power processor (LP) 342 and the main processor (MP) 344. For example, in some embodiments, the LR 312 and the MR 314 may be connected to and/or be controlled by the LP 342 and the MP 344, respectively, which are separate and/or discrete processors. In these embodiments, the LP 342 may operate at a lower power state than the MP 344 such that, when the UE is in the sleep state, the MP 344 may be powered off or in a low power state while the LP 342 can process any signals (e.g., such as a LP-WUS) received by the LR 312. In these embodiments, the operation of the LP 342 may consume less power than ordinary operations of the MP 344 would, thereby saving power of the UE 116 in the sleep state while maintaining the ability of the UE 116 to receive and process signals. In other embodiments, the LP 342 and the MP 344 may be components of the processor 340 where the LR 312 and the MR 314 may be connected to and/or be controlled by the LP 342 and the MP 344, respectively. In these embodiments, when the UE 116 is in the sleep state, MP 344 components of the processor 340 are powered off or in a low power state and LP 342 components operate to process signals (e.g., such as a LP-WUS) received by the LR 312. In these embodiments, the operation of the LP 342 components of the processor 340 may consume less power than ordinary operations of the processor 340 including the operations of the MP 344 components would, thereby saving power of the UE 116 in the sleep state while maintaining the ability of the UE 116 to receive and process signals.

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

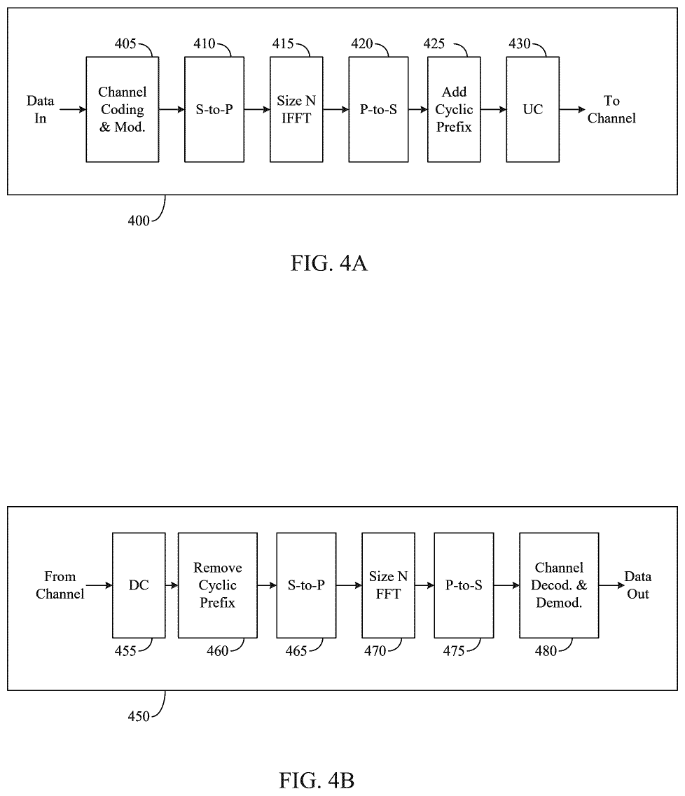

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured for slot format(s) with low power signals as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

NR supported discontinuous reception (DRX) for a UE in either RRC_IDLE/RRC_INACTIVE mode or RRC_CONNECTED mode, such that the UE could stop receiving signals or channels during the inactive period within the DRX cycle and save power consumption. In Rel-16, enhancement towards DRX for RRC_CONNECTED mode (e.g., connected-mode discontinuous reception (C-DRX)) was introduced, wherein a new DCI format was used to help the UE to skip a ON duration within a C-DRX cycle such that further power saving gain could be achieved. In Rel-17, enhancement towards DRX for RRC_IDLE/RRC_INACTIVE mode (e.g., idle mode DRX (I-DRX)) was introduced, wherein a paging early indication (PEI) was used for a UE to skip monitoring paging occasions such that extra power saving gain could be achieved.

However, embodiment of the present disclosure recognizes that the UE still needs to frequently wake up to monitor the new downlink control information (DCI) format or the PEI, such that the radio of the UE cannot be fully turned off for a long duration. To avoid such situation and to acquire further power saving gain, an additional receiver radio is provided, wherein the additional receiver radio can be used for monitoring a particular set of signals with very low power consumption, and the main receiver radio can be turned off or operating with a very lower power for a long duration.

Embodiments of the present disclosure provide a slot format implemented with the low power signals that could be received with low power, e.g., with a waveform enables reception using an additional receiver radio.

For one example, the low power signals can include a low power wake up signal, e.g., a low power signal for waking up the main receiver.

For another example, the low power signals can include a low power synchronization signal, e.g., a low power signal for synchronization with the low power receiver.

Embodiments of the present disclosure provide the slot format with the low power signal(s). More precisely, the following aspects are included in the invention:
Slot format determination based on the low power signal
Low power signal reception based on slot format

FIG. 5 illustrates a flowchart of an example UE procedure 500 for determining a slot format according to embodiments of the present disclosure. For example, procedure 500 for determining a slot format can be performed by any of the UEs 111-116 of FIG. 1, such as the UE 111. This example is for illustration only and other embodiments can be used without departing from the scope of the present disclosure.

The procedure begins in 501, a UE determines to receive low power signal(s) on a set of symbols/slots. In 502, the UE determines slot format for the set of symbols/slots as one of downlink, uplink, and/or flexible.

In one embodiment, a UE can determine a slot format based on a low power signal. For one instance, the slot format may include downlink symbols/slots, uplink symbols/slots, and/or flexible symbols/slots. For another instance, the slot format can be provided by a higher layer parameter that indicates the slot format (e.g., tdd-UL-DL-ConfigurationCommon or tdd-UL-DL-ConfigurationDedicated). For yet another instance, the slot format can be provided by a DCI format (e.g., DCI format 2_0).

For one example, for a set of symbols of a slot or a set of slots indicated to a UE (e.g., the UE 116) to receive the low power signal (e.g., by higher layer parameters and/or by a DCI format), the UE does not expect the set of symbols of a slot or the set of slots to be indicated as uplink by a higher layer parameter that indicates the slot format (e.g., tdd-UL-DL-ConfigurationCommon or tdd-UL-DL-ConfigurationDedicated).
For one sub-example, the low power signal according to one or more examples described herein is a signal for synchronization purpose with a low power on its reception procedure (e.g., low power synchronization signal (LP-SS)), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

For another example, for a set of symbols of a slot or a set of slots indicated to a UE to receive the low power signal (e.g., by higher layer parameters and/or by a DCI format), the UE does not expect the set of symbols of a slot or the set of slots to be indicated as flexible by a higher layer parameter that indicates the slot format (e.g., tdd-UL-DL-ConfigurationCommon or tdd-UL-DL-ConfigurationDedicated).
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

For one example, for a set of symbols of a slot or a set of slots, a UE does not expect to detect a DCI format that indicates the slot format (e.g., DCI format 2_0 with an SFI-index field value) indicating the set of symbols of a slot or the set of slots as uplink, and to detect that the UE is indicated to receive the low power signal in the set of symbols of a slot or the set of slots, e.g., by another DCI format and/or by higher layer parameters.
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

For another example, for a set of symbols of a slot or a set of slots that a UE is indicated to receive the low power signal, e.g., by another DCI format or by higher layer parameters, the UE does not expect to detect a DCI format that indicates the slot format (e.g., DCI format 2_0 with an SFI-index field value) indicating the set of symbols of a slot or the set of slots as uplink.
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

For yet another example, for a set of symbols of a slot or a set of slots that a UE is indicated to receive the low power signal, e.g., by another DCI format or by higher layer parameters, the UE expects to detect a DCI format that indicates the slot format (e.g., DCI format 2_0 with an SFI-index field value) indicating the set of symbols of a slot or the set of slots as downlink.
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

For one example, for a set of symbols of a slot or a set of slots indicated to a UE as flexible by a higher layer parameter that indicates the slot format (e.g., tdd-UL-DL-ConfigurationCommon or tdd-UL-DL-ConfigurationDedicated), or when the higher layer parameter that indicates the slot format (e.g., tdd-UL-DL-ConfigurationCommon or tdd-UL-DL-ConfigurationDedicated) is not provided to the UE, and if the UE detects a DCI format that indicates the slot format (e.g., DCI format 2_0 with an SFI-index field value) (e.g., indicating a slot format value other than 255), if the UE is indicated to receive the low power signal in the set of symbols of a slot or the set of slots, e.g., by another DCI format or by higher layer parameters, the UE does not expect the DCI format that indicates the slot format (e.g., DCI format 2_0 with an SFI-index field value) indicating the set of symbols of a slot or the set of slots as uplink.
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

For one example, a UE expects that flexible symbols and/or flexible slots for the reception of the low power signal are downlink symbols/slots, if the UE does not detect a DCI format that indicates the slot format (e.g., DCI format 2_0 with an SFI-index field value) indicating the corresponding symbols/slots as flexible or uplink, and the UE does not detect another DCI format indicating the UE to perform UL transmission (e.g., physical uplink shared channel (PUSCH), physical uplink control channel (PUCCH), physical random access channel (PRACH), or sounding reference signal (SRS)) in the symbols/slots.
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

With reference to FIG. 5, an example UE procedure for example of this embodiment is shown.

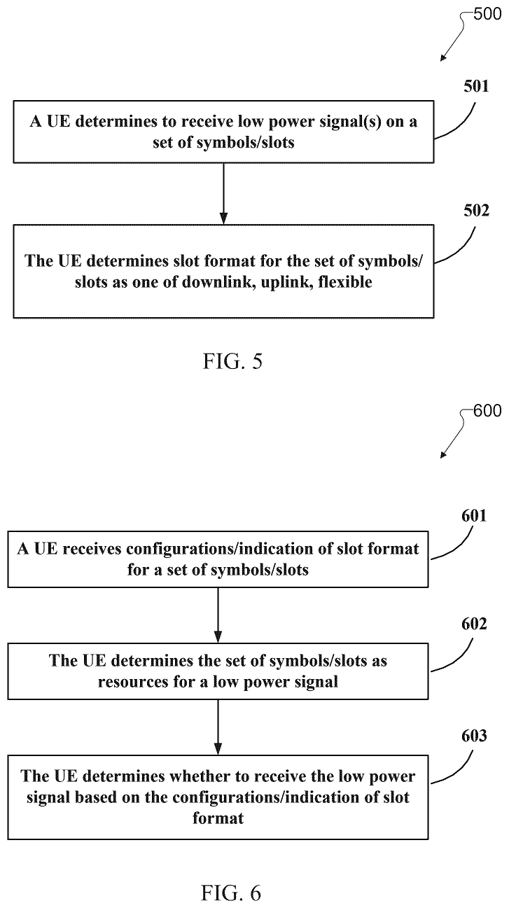

FIG. 6 illustrates a flowchart of an example UE procedure 600 for determining whether to receive a low power signal according to embodiments of the present disclosure. For example, procedure 600 for determining whether to receive a low power signal can be performed by any of the UEs 111-116 of FIG. 1, such as the UE 116. This example is for illustration only and other embodiments can be used without departing from the scope of the present disclosure.

The procedure begins in 601, a UE receives configurations/indication of slot format for a set of symbols/slots. In 602, the UE determines the set of symbols/slots as resources for a low power signal. In 603, the UE determines whether to receive the low power signal based on the configurations/indication of slot format.

In another embodiment, a UE can determine whether to receive a low power signal based on a slot format. For one instance, the slot format may include downlink symbols/slots, uplink symbols/slots, and/or flexible symbols/slots. For another instance, the slot format can be provided by a higher layer parameter that indicates the slot format (e.g., tdd-UL-DL-ConfigurationCommon or tdd-UL-DL-ConfigurationDedicated). For yet another instance, the slot format can be provided by a DCI format (e.g., DCI format 2_0).

For one example, for a set of symbols of a slot or a set of slots that are corresponding to a valid PRACH occasion and/or N_gap number of symbols/slots before the valid PRACH occasion, the UE does not receive the low power signal if a reception of the low power signal overlaps or partially overlaps with the set of symbols of a slot or a set of slots that are corresponding to a valid PRACH occasion and/or N_gap number of symbols/slots before the valid PRACH occasion. The UE does not expect the set of symbols of a slot or the set of slots to be indicated as downlink by a higher layer parameter that indicates the slot format (e.g., tdd-UL-DL-ConfigurationCommon or tdd-UL-DL-ConfigurationDedicated).
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

For another example, for a set of symbols of a slot or a set of slots that are corresponding to a valid PUSCH occasion and/or N_gap number of symbols/slots before the valid PUSCH occasion, the UE does not receive the low power signal if a reception of the low power signal overlaps or partially overlaps with the set of symbols of a slot or a set of slots that are corresponding to a valid PUSCH occasion and/or N_gap number of symbols/slots before the valid PUSCH occasion. The UE does not expect the set of symbols of a slot or the set of slots to be indicated as downlink by a higher layer parameter that indicates the slot format (e.g., tdd-UL-DL-ConfigurationCommon or tdd-UL-DL-ConfigurationDedicated).
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

For one example, the UE can receive the low power signal in a set of symbols of a slot or a set of slots, when at least one of the following conditions is satisfied; e.g., in a further consideration, otherwise, the UE does not receive the low power signal: 1) The UE is not configured to monitor PDCCH for a DCI format that indicates the slot format (e.g., DCI format 2_0). 2) The set of symbols of a slot or a set of slots are indicated as flexible by a higher layer parameter that indicates the slot format (e.g., tdd-UL-DL-ConfigurationCommon or tdd-UL-DL-ConfigurationDedicated), and/or the UE is not provided with a higher layer parameter that indicates the slot format (e.g., tdd-UL-DL-ConfigurationCommon or tdd-UL-DL-ConfigurationDedicated). 3) The UE receives a DCI format indicating the reception of the low power signal.
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

For another example, the UE can receive the low power signal in a set of symbols of a slot or a set of slots, when at least one of the following conditions is satisfied; e.g., in a further consideration, otherwise, the UE does not receive the low power signal: 1) The operation is on a signal carrier in unpaired spectrum. 2) The UE is configured by higher layers to receive the low power signal in the set of symbols of a slot or the set of slots. 3) The UE does not detect a DCI format that indicates to the UE to transmit an uplink transmission, e.g., at least one of a PUSCH, PUCCH, PRACH, or SRS in the set of symbols of a slot or the set of slots.
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

For one example, for a set of symbols of a slot or a set of slots that are indicated to a UE as uplink by a higher layer parameter that indicates the slot format (e.g., tdd-UL-DL-ConfigurationCommon or tdd-UL-DL-ConfigurationDedicated), the UE does not receive the low power signal when the low power signal overlaps or partially overlaps with the set of symbols of a slot or the set of slots; e.g., in a further consideration, otherwise, the UE does not receive the low power signal.
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

For another example, if a UE is indicated to receive the low power signal over multiple slots (or multiple slots together with multiple extra symbols), e.g., by higher layer parameters and/or by a DCI format, and if a higher layer parameter that indicates the slot format (e.g., tdd-UL-DL-ConfigurationCommon or tdd-UL-DL-ConfigurationDedicated) indicates that at least one symbol or one slot from the multiple slots for the low power signal reception is uplink, the UE does not receive the low power signal. In a further consideration, otherwise, the UE can receive the low power signal.
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

For one example, for a set of symbols of a slot or a set of slots indicated to a UE as flexible by a higher layer parameter that indicates the slot format (e.g., tdd-UL-DL-ConfigurationCommon or tdd-UL-DL-ConfigurationDedicated), or when the higher layer parameter that indicates the slot format (e.g., tdd-UL-DL-ConfigurationCommon or tdd-UL-DL-ConfigurationDedicated) is not provided to the UE, and/or if the UE detects a DCI format that indicates the slot format (e.g., DCI format 2_0 with an SFI-index field value), e.g., indicating a slot format value other than 255, if the DCI format that indicates the slot format (e.g., DCI format 2_0 with an SFI-index field value) also indicates the set of symbols of a slot or the set of slots as flexible, and the UE is indicated to receive the low power signal in the set of symbols of a slot or the set of slots, e.g., by another DCI format or by higher layer parameters, the UE receives the low power signal in the set of symbols of a slot or the set of slots. In a further consideration, otherwise, the UE does not receive the low power signal.
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

For another example, for a set of symbols of a slot or a set of slots indicated to a UE as flexible by a higher layer parameter that indicates the slot format (e.g., tdd-UL-DL-ConfigurationCommon or tdd-UL-DL-ConfigurationDedicated), or when the higher layer parameter that indicates the slot format (e.g., tdd-UL-DL-ConfigurationCommon or tdd-UL-DL-ConfigurationDedicated) is not provided to the UE, and/or if the UE detects a DCI format that indicates the slot format (e.g., DCI format 2_0 with an SFI-index field value), e.g., indicating a slot format value other than 255, if the UE is indicated to receive the low power signal in the set of symbols of a slot or the set of slots, e.g., by another DCI format or by higher layer parameters, the UE receives the low power signal in the set of symbols of a slot or the set of slots when the DCI format that indicates the slot format (e.g., DCI format 2_0 with an SFI-index field value) indicating the set of symbols of a slot or the set of slots as downlink. In a further consideration, otherwise, the UE does not receive the low power signal.
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

For yet another example, for a set of symbols of a slot or a set of slots indicated to a UE as flexible by a higher layer parameter that indicates the slot format (e.g., tdd-UL-DL-ConfigurationCommon or tdd-UL-DL-ConfigurationDedicated), or when the higher layer parameter that indicates the slot format (e.g., tdd-UL-DL-ConfigurationCommon or tdd-UL-DL-ConfigurationDedicated) is not provided to the UE, and/or if the UE detects a DCI format that indicates the slot format (e.g., DCI format 2_0 with an SFI-index field value), e.g., indicating a slot format value other than 255, if the DCI format that indicates the slot format (e.g., DCI format 2_0 with an SFI-index field value) also indicates the set of symbols of a slot or the set of slots as flexible, and the UE does not receive an indication to receive the low power signal in the set of symbols of a slot or the set of slots, e.g., by another DCI format or by higher layer parameters, the UE does not receive the low power signal in the set of symbols of a slot or the set of slots. In a further consideration, otherwise, the UE receives the low power signal.
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

For yet another example, for a set of symbols of a slot or a set of slots indicated to a UE as flexible by a higher layer parameter that indicates the slot format (e.g., tdd-UL-DL-ConfigurationCommon or tdd-UL-DL-ConfigurationDedicated), or when the higher layer parameter that indicates the slot format (e.g., tdd-UL-DL-ConfigurationCommon or tdd-UL-DL-ConfigurationDedicated) is not provided to the UE, and/or if the UE detects a DCI format that indicates the slot format (e.g., DCI format 2_0 with an SFI-index field value), e.g., indicating a slot format value other than 255, and if the UE is configured to receive the low power signal in the set of symbols of a slot or the set of slots, e.g., by higher layer parameters, the UE receives the low power signal in the set of symbols of a slot or the set of slots only when the DCI format that indicates the slot format (e.g., DCI format 2_0 with an SFI-index field value) indicates the set of symbols of a slot or the set of slots as downlink. Further, the set of symbols of a slot or the set of slots may be within the remaining channel occupancy duration, e.g., as indicated by the DCI format that indicates the slot format (e.g., DCI format 2_0 with an SFI-index field value). In a further consideration, otherwise, the UE does not receive the low power signal.
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

For one example, for a set of symbols of a slot or a set of slots that a UE is configured to receive the low power signal, if the UE detects a DCI format that indicates the slot format (e.g., DCI format 2_0 with an SFI-index field value), e.g., indicating a slot format value other than 255 and indicating that a subset of symbols in the set of symbols of a slot or a subset of symbols/slots within the set of slots as uplink or flexible, or the UE detects another DCI format indicating the UE to perform UL transmission (e.g., PUSCH, PUCCH, SRS or PRACH) in at least one symbol in the set of symbols of a slot or the set of slots, the UE cancels the reception of the low power signal in the set of symbols of a slot or the set of slots. In a further consideration, otherwise, the UE receives the low power signal.
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

For another example, for a set of symbols of a slot or a set of slots that a UE is configured to receive the low power signal, if the UE detects a DCI format that indicates the slot format (e.g., DCI format 2_0 with an SFI-index field value) indicating a slot format value other than 255 and indicating that a subset of symbols in the set of symbols of a slot or a subset of symbols/slots within the set of slots as uplink, or the UE detects another DCI format indicating the UE to perform UL transmission (e.g., PUSCH, PUCCH, SRS or PRACH) in at least one symbol in the set of symbols of a slot or the set of slots, the UE cancels the reception of the low power signal in the set of symbols of a slot or the set of slots. In a further consideration, otherwise, the UE receives the low power signal.
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

For yet another example, for operation with shared spectrum channel access and/or channel access mode is enabled (e.g., shared spectrum in FR1 or shared spectrum in FR2-2 with channel access mode enabled), if a UE is configured to receive the low power signal and provided a channel occupancy duration (e.g., by CO-DurationsPerCell), for a set of symbols of a slot or a set of slots that are indicated as downlink or flexible by a higher layer parameter that indicates the slot format (e.g., tdd-UL-DL-ConfigurationCommon or tdd-UL-DL-ConfigurationDedicated), the UE cancels the reception of the low power signal in the set of symbols of the slot or the set of slots that are not within the remaining channel occupancy duration (wherein the remaining channel occupancy duration is determined based on the provided channel occupancy duration). In a further consideration, otherwise, the UE receives the low power signal.
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

For one example, if a UE is indicated to receive the low power signal in one or more resource block (RB) sets in the frequency domain and in a set of symbols of a slot or a set of slots in the time domain, e.g., by a DCI format or by higher layer parameters, and the UE detects a DCI format that indicates the slot format (e.g., DCI format 2_0) indicating that any RB set from the one or more RB sets is not available for reception, the UE cancels the reception of the low power signal in the set of symbols of a slot or the set of slots. In a further consideration, otherwise, the UE receives the low power signal.
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

For another example, if a UE is indicated to receive the low power signal in one or more RB sets in the frequency domain and in a set of symbols of a slot or a set of slots in the time domain, e.g., by a DCI format or by higher layer parameters, and the UE detects a DCI format that indicates the slot format (e.g., DCI format 2_0) indicating that the RB sets from the one or more RB sets are available for reception, the UE receives the low power signal in the set of symbols of a slot or the set of slots only over the RB sets that are indicated as available for reception. In a further consideration, otherwise, the UE does not receive the low power signal.
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

For one example, for a set of symbols of a slot or a set of slots that are indicated as flexible by a higher layer parameter that indicates the slot format (e.g., tdd-UL-DL-ConfigurationCommon or tdd-UL-DL-ConfigurationDedicated), or when the higher layer parameter that indicates the slot format (e.g., tdd-UL-DL-ConfigurationCommon or tdd-UL-DL-ConfigurationDedicated) is not provided to the UE, and/or if the UE does not detect a DCI format that indicates the slot format (e.g., DCI format 2_0 with a slot format indication (SFI)-index field value) for the set of symbols of a slot or the set of slots, the UE receives the low power signal in the set of symbols of a slot or the set of slots, if the UE receives another DCI format that indicates the UE to receive the low power signal in the set of symbols of a slot or the set of slots. In a further consideration, otherwise, the UE does not receive the low power signal.
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

For another example, for a set of symbols of a slot or a set of slots that are indicated as flexible by a higher layer parameter that indicates the slot format (e.g., tdd-UL-DL-ConfigurationCommon or tdd-UL-DL-ConfigurationDedicated), or when the higher layer parameter that indicates the slot format (e.g., tdd-UL-DL-ConfigurationCommon or tdd-UL-DL-ConfigurationDedicated) is not provided to the UE, and/or if the UE does not detect a DCI format that indicates the slot format (e.g., DCI format 2_0 with an SFI-index field value) for the set of symbols of a slot or the set of slots, the UE receives the low power signal in the set of symbols of a slot or the set of slots, if the UE is configured to receive the low power signal in the set of symbols of a slot or the set of slots and the UE is provided with channel occupancy duration information (e.g., CO-DurationsPerCell) and determines that the set of symbols of a slot or the set of slots are within the remaining channel occupancy duration. In a further consideration, otherwise, the UE does not receive the low power signal.
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

For yet another example, for a set of symbols of a slot or a set of slots that are indicated as flexible by a higher layer parameter that indicates the slot format (e.g., tdd-UL-DL-ConfigurationCommon or tdd-UL-DL-ConfigurationDedicated), or when the higher layer parameter that indicates the slot format (e.g., tdd-UL-DL-ConfigurationCommon or tdd-UL-DL-ConfigurationDedicated) is not provided to the UE, and/or if the UE does not detect a DCI format that indicates the slot format (e.g., DCI format 2_0 with an SFI-index field value) for the set of symbols of a slot or the set of slots, the UE does not receive the low power signal in the set of symbols of a slot or the set of slots, if the UE is configured to receive the low power signal in the set of symbols of a slot or the set of slots and expect that the UE is provided with channel occupancy duration information (e.g., CO-DurationsPerCell) and determines that the set of symbols of a slot or the set of slots are within the remaining channel occupancy duration. In a further consideration, otherwise, the UE receives the low power signal.
For one sub-example, the low power signal according to one or more examples described herein is a signal for synchronization purpose with a low power on its reception procedure (e.g., LP-SS), e.g., optionally implemented with a waveform that enables reception on a receiver with low power.
For another sub-example, the low power signal according to one or more examples described herein is a signal for waking-up purpose with a low power on its reception procedure (e.g., LP-WUS), including another low power signal associated with the LP-WUS for synchronization purpose, e.g., optionally implemented with a waveform that enables reception on a receiver with low power.

With reference to FIG. 6, an example UE procedure for example of this embodiment is shown.

NR supported discontinuous reception (DRX) for a UE (e.g., the UE 116) in either RRC_IDLE/RRC_INACTIVE mode or RRC_CONNECTED mode, such that the UE could stop receiving signals or channels during the inactive period within the DRX cycle and save power consumption. In Rel-16, enhancement towards DRX for RRC_CONNECTED mode (e.g., C-DRX) was introduced, wherein a new DCI format was used to help the UE to skip a ON duration within a C-DRX cycle such that further power saving gain could be achieved. In Rel-17, enhancement towards DRX for RRC_IDLE/RRC_INACTIVE mode (e.g., I-DRX) was introduced, wherein a paging early indication (PEI) was used for a UE to skip monitoring paging occasions such that extra power saving gain could be achieved.

However, the UE still needs to frequently wake up to monitor the new DCI format or the PEI, such that the radio of the UE cannot be fully turned off for a long duration. To avoid such situation and to acquire further power saving gain, an additional receiver radio is provided, wherein the additional receiver radio can be used for monitoring a particular set of signals with very low power consumption, and the main receiver radio can be turned off or operating with a very lower power for a long duration.

At the same time, for a UE in RRC_CONNECTED mode, the UE can be configured with at least one of a cell discontinuous transmission (DTX) and/or a cell discontinuous reception (DRX) operation for a serving cell. When the cell DTX operation is configured and activated for the concerned cell, the UE may not monitor PDCCH in selected cases or does not monitor semi-persistent scheduling (SPS) occasions during cell DTX non-active duration. When the cell DRX operation is configured and activated for the concerned cell, the UE does not transmit on cell group (CG) resources or does not transmit a scheduling request (SR) during cell DRX non-active duration.

Embodiments of the present disclosure provide the cell discontinuous transmission and/or reception operation implemented with the low power signals that could be received with low power, e.g., with a waveform enables reception using an additional receiver radio.

For one example, the low power signals can include a low power wake up signal, e.g., a low power signal for waking up the main receiver, which could include another low power signal associated with the low power wake up signal for synchronization purpose.

For another example, the low power signals can include a low power synchronization signal, e.g., a low power signal for synchronization with the low power receiver.

In one regard, the active duration of the cell DTX operation can be aligned with the active duration of the cell DRX operation, e.g., the active duration in the disclosure can be commonly applicable to both cell DTX and cell DRX operations, when they are both configured.

In another regard, the active duration of the cell DTX operation can be aligned with the active duration of the UE C-DRX operation, e.g., the active duration in the disclosure can be commonly applicable to both cell DTX operation and UE C-DRX operation, when they are both configured.

In one aspect of this disclosure, the UE is at least in RRC_CONNECTED mode, and the corresponding DRX operation is UE C-DRX operation.

Embodiments of the present disclosure provide a cell DTX/DRX operation with the low power signal(s). More precisely, the following aspects are included in the invention:
Interaction between cell DTX/DRX operation and operation for LP-WUS
   Relationship between cell DTX/DRX configuration and LP-WUS configuration
   Relationship between cell DTX/DRX configuration and LP-WUS monitoring occasion
   LP-WUS monitoring behavior when cell DTX/DRX is configured
Cell DTX/DRX operation impacted by LP-WUS monitoring
   Activation/deactivation of cell DTX/DRX operation based on LP-WUS reception and/or indication by LP-WUS
   DCI format 2_9 monitoring based on the indication by LP-WUS

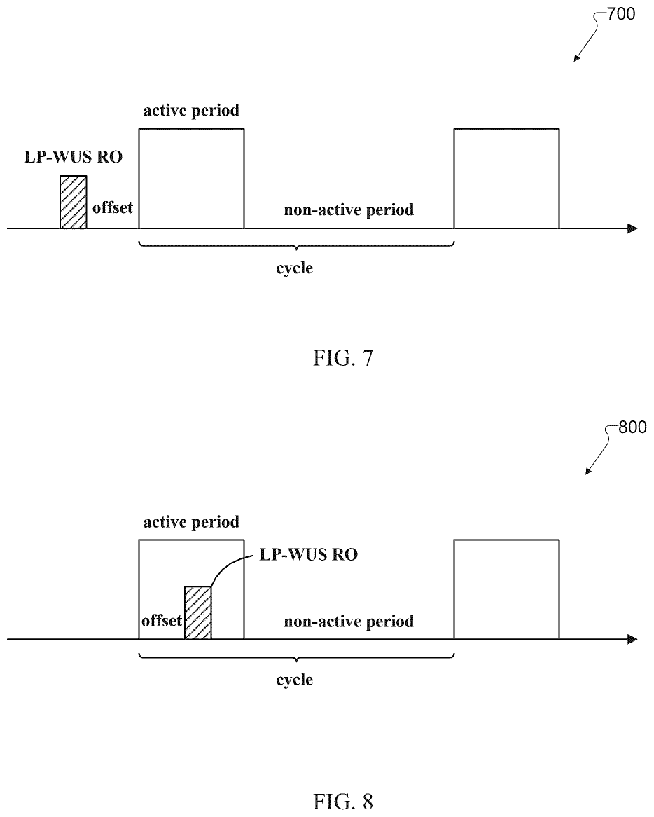

FIG. 7 illustrates a diagram of an example LP-WUS reception/monitoring occasion(s) 700 according to embodiments of the present disclosure. For example, LP-WUS reception/monitoring occasion(s) 700 can be utilized by any of the UEs 111-116 of FIG. 1, such as the UE 114. This example is for illustration only and can be used without departing from the scope of the present disclosure.

In one embodiment, a UE can be provided with a first operation as the LP-WUS monitoring and a second operation from at least one of a cell DTX operation and/or a cell DRX operation.

In one example, the first operation has a first cycle, a first offset for a first active duration, and/or a first length of the first active duration.

In another example, the second operation has a second cycle, a second offset for a second active duration, and a second length of the second active duration.

In one example, there can be an alignment between the first active duration in the first operation and the second active duration in the second operation, such that the two active durations overlap or partially overlap.
For one instance, the first offset in the first operation is same as the second offset in the second operation.
For another instance, the first length in the first operation is same as the second length in the second operation.
For yet another instance, the first cycle in the first operation is same as the second cycle in the second operation.
For yet another instance, the first cycle in the first operation is an integer multiple of the second cycle in the second operation.
For yet another instance, the second cycle in the second operation is an integer multiple of the first cycle in the first operation.

In another example, there can be a mis-alignment between the first active duration in the first operation and the second active duration in the second operation, such that the two active durations do not overlap.
For one instance, the first offset in the first operation can be different from the second offset in the second operation.
For another instance, the first length in the first operation can be same as or different from the second length in the second operation.
For yet another instance, the first cycle in the first operation is same as the second cycle in the second operation.
For yet another instance, the first cycle in the first operation is an integer multiple of the second cycle in the second operation.
For yet another instance, the second cycle in the second operation is an integer multiple of the first cycle in the first operation.

In yet another example, the first active duration in the first operation can be located within the second non-active duration in the second operation.
For one instance, the first offset in the first operation can be different from the second offset in the second operation.
For another instance, the first length in the first operation can be same as or different from the second length in the second operation.
For yet another instance, the first cycle in the first operation is same as the second cycle in the second operation.
For yet another instance, the first cycle in the first operation is an integer multiple of the second cycle in the second operation.
For yet another instance, the second cycle in the second operation is an integer multiple of the first cycle in the first operation.

In one example, when the second operation (e.g., cell DTX operation) is configured and/or activated, the monitoring/reception occasion(s) for LP-WUS are located in the second non-active duration in the second operation (e.g., the UE does not monitor LP-WUS in active duration in the second operation). With reference to FIG. 7, an illustration of this example is shown.
For one instance, a LP-WUS monitoring/reception occasion or a first LP-WUS monitoring/reception occasion within a burst of LP-WUS monitoring/reception occasions can be determined based on an offset with respect to the start of active period of the second operation.
For another instance, the periodicity of LP-WUS monitoring/reception occasion is same as the second cycle in the second operation.
For yet another instance, the periodicity of LP-WUS monitoring/reception occasion is an integer multiple of the second cycle in the second operation.
For yet another instance, the second cycle in the second operation is an integer multiple of the periodicity of LP-WUS monitoring/reception occasion.

FIG. 8 illustrates a diagram of an example LP-WUS reception/monitoring occasion(s) 800 according to embodiments of the present disclosure. For example, LP-WUS reception/monitoring occasion(s) 800 can be done by the UE 115 of FIG. 1. This example is for illustration only and can be used without departing from the scope of the present disclosure.

In another example, when the second operation (e.g., cell DTX operation) is configured and/or activated, the monitoring occasion(s) for LP-WUS are located in the second active duration in the second operation. With reference to FIG. 8, an illustration of this example is shown.
For one instance, a LP-WUS monitoring/reception occasion or a first LP-WUS monitoring/reception occasion within a burst of LP-WUS monitoring/reception occasions can be determined based on an offset with respect to the start of active period of the second operation.
For another instance, the periodicity of LP-WUS monitoring/reception occasion is same as the second cycle in the second operation.
For yet another instance, the periodicity of LP-WUS monitoring/reception occasion is an integer multiple of the second cycle in the second operation.
For yet another instance, the second cycle in the second operation is an integer multiple of the periodicity of LP-WUS monitoring/reception occasion.

In one example, when the second operation (e.g., cell DTX operation) is configured and/or activated, a UE does not monitor or receive LP-WUS in the non-active period of the second operation.
For one instance, the monitoring/reception occasion for the LP-WUS can be located in the non-active period of the second operation, and the UE skips the LP-WUS monitoring/reception on that occasion, when the second operation (e.g., cell DTX operation) is configured and activated.

In another example, when the second operation (e.g., cell DTX operation) is configured and/or activated, a UE does not monitor or receive LP-WUS in the active period of the second operation.
For one instance, the monitoring/reception occasion for the LP-WUS can be located in the active period of the second operation, and the UE skips the LP-WUS monitoring/reception on that occasion, when the second operation (e.g., cell DTX operation) is configured and activated.

In yet another example, when the second operation (e.g., cell DTX operation) is configured and/or activated, a UE's behavior on monitoring/reception of LP-WUS is not impacted.

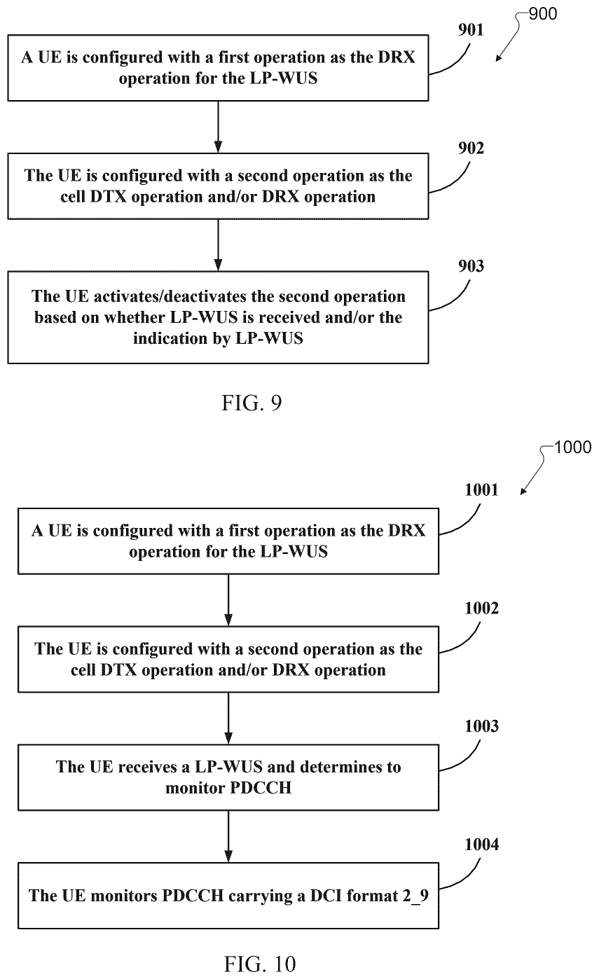

FIG. 9 illustrates a flowchart of an example UE procedure 900 for activation/deactivation of cell DTX/DRX operations according to embodiments of the present disclosure. For example, procedure 900 for activation/deactivation of cell DTX/DRX operations can be performed by any of the UEs 111-116 of FIG. 1, such as the UE 113. This example is for illustration only and other embodiments can be used without departing from the scope of the present disclosure.

The procedure begins in 901, a UE is configured with a first operation as the DRX operation for the LP-WUS. In 902, the UE is configured with a second operation as the cell DTX operation and/or DRX operation. In 903, the UE activates/deactivates the second operation based on whether LP-WUS is received and/or the indication by LP-WUS.

In one embodiment, a UE can be provided with a first operation as the LP-WUS monitoring and a second operation from at least one of a cell DTX operation and/or a cell DRX operation. The UE can determine whether to activate or deactivate the cell DTX operation and/or the cell DRX operation based on the indication and/or reception of the LP-WUS. In another consideration, the UE can determine whether to skip a next active duration of the cell DTX operation and/or the cell DRX operation based on the indication and/or reception of the LP-WUS.

In one example, when the second operation (e.g., cell DTX operation) is configured and/or activated, and when the UE is configured with a first operation as the LP-WUS monitoring, if the UE receives a LP-WUS and determines to receive PDCCH based on the indication in the LP-WUS, the UE deactivates the second operation (e.g., cell DTX operation).

In another example, when the second operation (e.g., cell DTX operation) is configured, and when the UE is configured with a first operation as the LP-WUS monitoring, if the UE receives a LP-WUS and determines to receive PDCCH based on the indication in the LP-WUS, the UE activates the second operation (e.g., cell DTX operation).

In yet another example, when the second operation (e.g., cell DTX operation) is configured, and when the UE is configured with a first operation as the LP-WUS monitoring, if the UE receives a LP-WUS and determines not to receive PDCCH based on the indication in the LP-WUS, the UE activates the second operation (e.g., cell DTX operation).

In yet another example, when the second operation (e.g., cell DTX operation) is configured, and when the UE is configured with a first operation as the LP-WUS monitoring, if the UE receives a LP-WUS and determines not to receive PDCCH based on the indication in the LP-WUS, the UE deactivates the second operation (e.g., cell DTX operation).

In yet another example, when the second operation (e.g., cell DTX operation) is configured, and when the UE is configured with a first operation as the LP-WUS monitoring, if the UE does not receive a LP-WUS, the UE activates the second operation (e.g., cell DTX operation).

In yet another example, when the second operation (e.g., cell DTX operation) is configured, and when the UE is configured with a first operation as the LP-WUS monitoring, if the UE does not receive a LP-WUS, the UE deactivates the second operation (e.g., cell DTX operation).

In yet another example, when the second operation (e.g., cell DTX operation and/or cell DRX operation) is configured, and when the UE is configured with a first operation as the LP-WUS monitoring, if the UE receives a LP-WUS indicating to skip enabling the timer associated with the next active time of the second operation, the UE skips enabling the timer associated with the next active time of the second operation (e.g., do not monitor PDCCH in the next active time of the second operation). In one further consideration, if the UE receives a LP-WUS indicating to start the timer associated with the next active time of the second operation, the UE start the timer associated with the next active time of the second operation (e.g., monitor PDCCH in the next active time of the second operation).

With reference to FIG. 9, an example UE procedure for at least one example described herein of this embodiment is shown.

FIG. 10 illustrates a flowchart of an example UE procedure 1000 for monitoring PDCCH according to embodiments of the present disclosure. For example, procedure 1000 for monitoring PDCCH can be performed by the UE 116 of FIG. 3. This example is for illustration only and other embodiments can be used without departing from the scope of the present disclosure.

The procedure begins in 1001, a UE is configured with a first operation as the LP-WUS monitoring. In 1002, the UE is configured with a second operation as the cell DTX operation and/or DRX operation. In 1003, the UE receives a LP-WUS and determines to monitor PDCCH. In 1004, the UE monitors PDCCH carrying a DCI format 2_9.

In one example, when the second operation (e.g., cell DTX operation) is configured, and when the UE is configured with a first operation as the LP-WUS monitoring, if the UE receives a LP-WUS and/or determine to receive PDCCH based on the indication in LP-WUS, the PDCCH to be received by the UE includes a PDCCH carrying a DCI format 2_9.

With reference to FIG. 10, an example UE procedure for at least one example described herein of this embodiment is shown.

Any of the above variation embodiments can be utilized independently or in combination with at least one other variation embodiment. The above flowchart illustrates example methods that can be implemented in accordance with the principles of the present disclosure and various changes could be made to the methods illustrated in the flowchart herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive a set of higher layer parameters;
a low-power receiver (LR); and
a processor operably coupled to the transceiver and the LR, the processor configured to:
determine whether a first slot format is included in the set of higher layer parameters;
determine, based on the set of higher layer parameters, a set of slots for receiving a low power signal by the LR; and
when the first slot format is included in the set of higher layer parameters, determine, based on the first slot format, whether a slot in the set of slots is an uplink slot, a flexible slot, or a downlink slot;
wherein the LR is further configured to receive the low power signal based on a determination that slot in the set of slots is not an uplink slot.

2. The UE of claim 1, wherein the low power signal is a low power synchronization signal (LP-SS) or a low power wake up signal (LP-WUS).

3. The UE of claim 1, wherein the processor is further configured to identify the slot as a downlink slot when the slot is determined as a flexible slot based on the first slot format.

4. The UE of claim 1, wherein the low power signal is received further based on a determination that the set of slots (i) do not overlap with a valid physical random access channel (PRACH) occasion and (ii) do not overlap with a valid physical uplink shared channel (PUSCH) occasion.

5. The UE of claim 1, wherein the low power signal is received further based on a determination that the UE is not indicated to perform an uplink transmission in the set of slots.

6. The UE of claim 1, wherein:
the transceiver is further configured to receive a downlink control information (DCI) format;
the DCI format includes a second slot format;
the processor is further configured to determine, based on the second slot format, whether slots in the set of slots are downlink slots; and
the LR is further configured to receive the low power signal further based on a determination that the first slot format is not included in the set of higher layer parameters and all slots in the set of slots are downlink slots.

7. The UE of claim 1, wherein the processor is further configured to cancel reception of the low power signal, when any slot in the set of slots is not within a remaining channel occupancy duration for an operation with a shared spectrum channel access.

8. The UE of claim 1, wherein:
the processor is further configured to determine, based on the set of higher layer parameters, configurations for a cell discontinuous transmission (DTX) operation, and
the configurations include an active duration in a DTX cycle for the cell DTX operation.

9. The UE of claim 8, wherein the low power signal is received outside the active duration.

10. The UE of claim 8, wherein the low power signal includes an indication on whether to receive a signal or a channel using the transceiver for a next DTX cycle for the cell DTX operation.

11. A method of a user equipment (UE) in a wireless communication system, the method comprising:
receiving a set of higher layer parameters;
determining whether a first slot format is included in the set of higher layer parameters;
determining, based on the set of higher layer parameters, a set of slots for receiving a low power signal by a low-power receiver (LR) of the UE;
when the first slot format is included in the set of higher layer parameters, determining, based on the first slot format, whether a slot in the set of slots is an uplink slot, a flexible slot, or a downlink slot; and
receiving the low power signal based on a determination that the slot in the set of slots is not an uplink slot.

12. The method of claim 11, wherein the low power signal is a low power synchronization signal (LP-SS) or a low power wake up signal (LP-WUS).

13. The method of claim 11 further comprising identifying the slot in the set of slots as a downlink slot when the slot is determined as a flexible slot based on the first slot format.

14. The method of claim 11, wherein receiving the low power signal further comprises receiving the low power signal further based on a determination that the set of slots (i) do not overlap with a valid physical random access channel (PRACH) occasion and (ii) do not overlap with a valid physical uplink shared channel (PUSCH) occasion.

15. The method of claim 11, wherein receiving the low power signal further comprises receiving the low power signal further based on a determination that the UE is not indicated to perform an uplink transmission in the set of slots.

16. The method of claim 11 further comprising:
receiving a downlink control information (DCI) format, wherein the DCI format includes a second slot format; and
determining, based on the second slot format, whether a slot in the set of slots are downlink slots,
wherein receiving the low power signal further comprises receiving the low power signal further based on a determination that the first slot format is not included in the set of higher layer parameters, and all slots in the set of slots are downlink slots.

17. The method of claim 11 further comprising canceling reception of the low power signal, when any slot in the set of slots is not within a remaining channel occupancy duration for an operation with a shared spectrum channel access.

18. The method of claim 11 further comprising:
determining, based on the set of higher layer parameters, configurations for a cell discontinuous transmission (DTX) operation,
wherein the configurations include an active duration in a DTX cycle for the cell DTX operation.

19. The method of claim 18, wherein the low power signal is received outside the active duration.

20. The method of claim 18, wherein the low power signal includes an indication on whether to receive a signal or a channel using a transceiver of the UE for a next DTX cycle for the cell DTX operation.
